(19) United States
(12) Patent Application Publication
(10) Pub. No.: US 2012/0207241 A1
(43) Pub. Date: Aug. 16, 2012

(54) Bit Allocation Apparatus, Transmitter, Bit Allocation Method and Power Allocation Method

(75) Inventors: Hao WANG, Beijing (CN); Jun TIAN, Beijing (CN)

(73) Assignee: FUJITSU LIMITED, Kawasaki-shi (JP)

(21) Appl. No.: 13/366,470

(22) Filed: Feb. 6, 2012

(30) Foreign Application Priority Data
Feb. 10, 2011 (CN) 201110035851.6

(51) Int. Cl. H04B 1/02

(52) U.S. Cl. 375/295

(57) ABSTRACT

The present invention relates to a bit allocation apparatus, a transmitter, a bit allocation method and a power allocation method. The apparatus comprises: a selecting unit, for selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and an allocating unit, for allocating code word bits to be allocated to modulation symbols in the collection of modulation symbols selected by the selecting unit. The apparatus may select a sub-collection with good performance from a predetermined number of modulation symbols or subcarriers to allocate bits, thereby ensuring that the demodulation algorithm output optimal soft demodulating information.

### TECHNICAL FIELD

The present invention relates to the field of wireless communication, and in particular to a bit allocation apparatus, a transmitter, a bit allocation method and a power allocation method.

### BACKGROUND ART

An orthogonal frequency division multiplexing (OFDM) is a multicarrier transmission technology under the mobile communication environment, having an outstanding feature of dividing a frequency band into several subcarriers, thereby converting a frequency selective channel into a series orthogonal flat fading channels.

In an OFDM system, the modulation scheme of a transmitter may be adaptively adjusted based on the channel state information (CSI) of each subcarrier fed back by the receiver, the essence of which being to allocate numbers of bits to each subcarrier according to different channel conditions, this is an adaptive bit loading (ABL) algorithm. Currently, the object of most of ABL algorithms is to optimize the bit-error rate of the non-encoded system, since the bit-error rate may be accurately mathematically modeled, it is very convenient for the algorithm design.^{[1]} Some other methods are to maximize the signal to noise ratio (SNR) of the subcarrier, thereby obtaining better bit error performances.^{[2]}[1] “A new loading algorithm for discrete multitone transmission”. GLOBECOM'96[2] “Simplified Soft-output Demmapper for Binary Interleaved COFDM with Application to HIPERLAN/2, ICC'02”.

However, in the process carrying out the present invention, the applicant found that following defects existed in the prior art: for an encoded system, the above ABL could not fully use the feedback information, and could not optimize to a bit metric; in addition, in an encoded system, a decoding algorithm for a soft-input and soft-output (i.e. real numbers are output) is one of the key factors for deciding the system performance. Therefore, it is necessary for a demodulation algorithm to provide soft demodulation information as accurate as possible, so as to ensure the correct decoding of the decoder.

### SUMMARY OF THE INVENTION

The embodiments of the present invention provide a bit allocation apparatus, a transmitter, a bit allocation method and a power allocation method. The methods may be applicable to a single carrier or multicarriers, selecting a sub-collection of good performance from a predetermined number of modulation symbols or subcarriers to allocate bits by indicating the bit metric of the channel quality of each of the bit locations in each of the modulation symbols or subcarriers, thereby simplifying greatly the ABL algorithms, and the bit metric ensuring that the demodulation algorithms output optimal soft demodulating information.

According to one aspect of the embodiments of the present invention, there is provided a bit allocation apparatus, comprising:

a selecting unit, for selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and

an allocating unit, for allocating code word bits to be allocated to modulation symbols in the collection of modulation symbols selected by the selecting unit.

According to another aspect of the embodiments of the present invention, there is provided a transmitter, comprising:

an encoding unit, for encoding information to be transmitted;

an interleaving unit, connected with the encoding unit, for interleaving the encoded information;

a bit allocating unit, connected with the interleaving unit, for allocating the interleaved information to a predetermined number of symbols; wherein the allocating unit comprises the bit allocation apparatus according to any one of claims 1 to 6; and

a transmitting unit, connected with the bit allocating unit, for transmitting the information.

According to a further aspect of the embodiments of the present invention, there is provided a bit allocation method, comprising:

selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and

allocating code word bits to be allocated to modulation symbols in the selected collection of modulation symbols.

According to still another aspect of the embodiments of the present invention, there is provided a power allocation method, comprising:

calculating a power allocation coefficient on each modulation symbol according to a modulation scheme of each modulation symbol in a collection of modulation symbols; the power allocation coefficient being obtained according to a signal-to-noise ratio or a channel gain on each of the modulation symbols, and according to a location of each bit at the modulation symbols and a modulation order; and

determining a power on each modulation symbol according to the power allocation coefficient and a total transmission power.

The advantages of the embodiments of the present invention exist in that the methods may be applicable to a single carrier or multicarriers, selecting a sub-collection with good performance from a predetermined number of modulation symbols or subcarriers to allocate bits according to the bit metric indicative of the channel quality of each of the bit locations in each of the modulation symbols or subcarriers, thereby simplifying greatly the ABL algorithms, and the bit metric may ensure that the demodulation algorithms output optimal soft demodulating information.

The particular embodiments of the present invention are disclosed with reference to the following description and accompanying drawings, indicating the manners in which the principle of the present invention may be adopted. It should be understood that the scope of the embodiments of the present invention are limited thereto. The embodiments of the present invention comprise many alterations, modifications and equivalents.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The aforementioned and other objectives, characteristics and advantages of the embodiments according to the present invention will become more apparent in the following detailed descriptions in combination with the accompanying drawings, in which

FIG. 1 is a schematic view illustrating the configuration of the bit allocation apparatus according to Embodiment 1 of the present invention;

FIG. 2 is a first schematic view illustrating the configuration of the allocating unit according to Embodiment 1 of the present invention;

FIG. 3 is a first flowchart showing the operation of the bit allocation apparatus according to Embodiment 1 of the present invention;

FIG. 4 is a second schematic view illustrating the configuration of the allocating unit according to Embodiment 1 of the present invention;

FIG. 5 is a second flowchart showing the operation of the bit allocation apparatus according to Embodiment 1 of the present invention;

FIG. 6 is a schematic view illustrating the configuration of the transmitter according to Embodiment 3 of the present invention;

FIG. 7 is a schematic view illustrating the configuration of the transmitter according to Embodiment 4 of the present invention; and

FIG. 8 is a flowchart showing the power allocation method according to Embodiment 5 of the present invention.

### DETAILED DESCRIPTION OF THE INVENTION

Various embodiments of the present invention will be described in the following with reference to the accompanying drawings. These embodiments are exemplary only and not intended to limit the present invention. Bit allocation in a single carrier system and a multicarrier OFDM system will be taken as an example in describing the embodiments of the present invention. However, it should be understood that the present invention is not limited to the above systems, and is applicable to systems concerning any bit allocation.

The embodiments of the present invention provide a bit allocation method, comprising:

selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and

allocating code word bits to be allocated to modulation symbols in the selected collection of modulation symbols.

FIG. 1 is a schematic view illustrating the configuration of the bit allocation apparatus according to Embodiment 1 of the present invention. As shown in FIG. 1, the apparatus comprises a selecting unit 101 and an allocating unit 102, wherein

the selecting unit 101 is used to select a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and

the allocating unit 102 is used to allocate code word bits to be allocated to modulation symbols in the collection of modulation symbols selected by the selecting unit 101.

It can be seen from the above embodiment that the ABL algorithms are greatly simplified by selecting a sub-collection with good performance from a predetermined number of modulation symbols to allocate bits based on the bit metric indicative of the channel quality of each of the bit locations in each of the modulation symbols, and the bit metric may ensure that the demodulation algorithms output optimal soft demodulation information.

In this embodiment, the bit metric A is determined according to the signal to noise ratio β or the channel gain |h|² of the modulation symbols, the modulation scheme of the modulation symbols and the locations of bits on the modulation symbols. That is to say, the bit metric Λ̅ is a function of the signal to noise ratio β or the channel gain |h|², and may indicate the equivalent channel quality of each of the bits locations in each of the modulation symbols.

For example, a signal to noise ratio is a common symbol-level metric, and can evaluate the quality of each of the modulation symbols under the current fading channel. To be simple, if the signal to noise ratio β of a certain modulation symbol is relatively high, it shows that the channel conditions of the current modulation symbol is relatively good, and relatively higher modulation order and relatively lower transmission power may be allocated; to the contrary, relatively lower modulation order and relatively higher transmission power should be allocated, so as to ensure to use the channel bandwidth to the most great extent while obtaining the required reliability.

In this way, the symbol metric is converted into a bit metric by using the bit metric.

In this embodiment, the method for obtaining bit metric is described in detail taking QPSK, 16QAM and 64QAM modulation schemes as examples.

As described in Background Art, the precision of a modulation algorithm has an essential effect on the performance of a receiver system. Therefore, in this embodiment, bit metrics may be obtained by a plurality of manners, for example, a bit metric is taken as a mean square value of soft modulation output bit soft information, i.e. the bit metric is:

Λ̅=E(LLR²) (1).

However, it is not limited thereto, and it may be other metric values, such as bit mutual information, etc. Following description is given taking that the bit metric is a mean square value as an example.

The soft modulation algorithm in document [2] is adopted, for example, for 64QAM, 16QAM and QPSK modulations, such a simplified soft modulation formula can be written as:

$$\begin{matrix}{LLR}_{64 QAM} ( {b}_{0} ) = \frac{2 / \sqrt{42}}{{σ}_{w , I}^{2}} \cdot {y}_{l}^{I} \\ {LLR}_{64 QAM} ( {b}_{1} ) = \frac{2 / \sqrt{42}}{{σ}_{w , I}^{2}} \cdot ( \frac{4}{\sqrt{42}} - \vert {y}_{l}^{I} \vert ) \\ {LLR}_{64 QAM} ( {b}_{2} ) = \frac{2 / \sqrt{42}}{{σ}_{w , I}^{2}} \cdot ( \frac{2}{\sqrt{42}} - \vert \frac{4}{\sqrt{42}} - \vert {y}_{l}^{I} \vert \vert ) & ( 2 ) \\ {LLR}_{16 QAM} ( {b}_{0} ) = \frac{2 / \sqrt{10}}{{σ}_{w , I}^{2}} \cdot {y}_{I} ( i ) \\ {LLR}_{16 QAM} ( {b}_{1} ) = \frac{2 / \sqrt{10}}{{σ}_{w , I}^{2}} \cdot ( \frac{2}{\sqrt{10}} - \vert {y}_{I} ( i ) \vert ) & ( 3 ) \\ {LLR}_{QPSK} ( {b}_{0} ) = \frac{\sqrt{2}}{{σ}_{w , I}^{2}} \cdot {y}_{I} ( i ) & ( 4 )\end{matrix}$$

where, yₗ(i) represents the cophase component of the receiving symbol, and σ²_{w,l} represents the noise variance of the cophase component.

The formulae of the bit metrics to which the 64QAM, 16QAM and QPSK modulation schemes correspond may be derived based on the above formulae (1) and (2), (1) and (3), and (1) and (4).

A first case: if the bit metric is a function of the modulation symbol channel gain |h|²

1. for a 64QAM modulation scheme, the respective bit metrics of each of the bits (0-5) on modulation symbol d are:

$$\begin{matrix}{Λ}_{d , 0} = {Λ}_{d , 3} = \frac{{\vert h \vert}^{2}}{\sqrt{21}} & ( 1 \text{-} 1 ) \\ {Λ}_{d , 1} = {Λ}_{d , 4} = \frac{\sqrt{5} {\vert h \vert}^{2}}{21} & ( 1 \text{-} 2 ) \\ {Λ}_{d , 2} = {Λ}_{d , 5} = \frac{{\vert h \vert}^{2}}{21} & ( 1 \text{-} 3 )\end{matrix}$$

2. for a 16QAM modulation scheme, the respective bit metrics of each of the bits (0-3) on modulation symbol d are:

$$\begin{matrix}{Λ}_{d , 0} = {Λ}_{d , 2} = \frac{{\vert h \vert}^{2}}{\sqrt{5}} & ( 2 \text{-} 1 ) \\ {Λ}_{d , 1} = {Λ}_{d , 3} = \frac{{\vert h \vert}^{2}}{5} & ( 2 \text{-} 2 )\end{matrix}$$

3. for a QPSK modulation scheme, the respective bit metrics of each of the bits (0-1) on modulation symbol d are:

Λ_{d,0}=Λ_{d,2}=|h|² (3-1)

A second case: if the bit metric is a function of the signal to noise ratio β on the modulation symbol

1. for a 64QAM modulation scheme, the respective bit metrics of each of the bits (0-5) on modulation symbol d are:

$$\begin{matrix}{Λ}_{d , 0} = {Λ}_{d , 3} = \frac{4}{21} β ( β + 1 ) & ( 4 \text{-} 1 ) \\ {Λ}_{d , 1} = {Λ}_{d , 4} = \frac{4}{21} β ( \frac{5}{21} β + 1 ) & ( 4 \text{-} 2 ) \\ {Λ}_{d , 2} = {Λ}_{d , 5} = \frac{4}{21} β ( \frac{1}{21} β + 1 ) & ( 4 \text{-} 3 )\end{matrix}$$

2. for a 16QAM modulation scheme, the respective bit metrics of each of the bits (0-3) on modulation symbol d are:

$$\begin{matrix}{Λ}_{d , 0} = {Λ}_{d , 2} = \frac{4}{5} β ( β + 1 ) & ( 5 \text{-} 1 ) \\ {Λ}_{d , 1} = {Λ}_{d , 3} = \frac{4}{5} β ( \frac{β}{5} + 1 ) & ( 5 \text{-} 2 )\end{matrix}$$

3. for a QPSK modulation scheme, the respective bit metrics of each of the bits (0-1) on modulation symbol d are:

Λ_{d,0}=Λ_{d,2}=4β(β+1) (6-1).

In this embodiment, a predetermined number of modulation symbols may be made to be equivalent to a plurality of binary channels, with the number of the binary channels corresponding to the number of the bits locations on the modulation symbols, i.e. 2×D×m, and the maximum number being 2×D×mₘₐₓ, where, m is the modulation order, and mₘₐₓ is the maximum modulation order. Thus, the bit metric indicates the channel quality of each of the binary channels.

In this embodiment, the number of the plurality of modulation symbols is D, the maximum modulation orders is mₘₐₓ, the maximum number of bit locations (binary channels) of the plurality of modulation symbols is 2×D×mₘₐₓ, the number of the code word bits is B, and B<D×2mₘₐₓ (that is, if each of the modulation symbols are allocated according to the maximum modulation orders, there will exist redundant modulation symbols).

If B numbers of code word bits are mapped to D numbers of modulation symbols, the selecting unit 101 may select a modulation symbol collection from a plurality of modulation symbols according to a bit metric, such that the sum of the bits on the modulation symbols contained in the modulation symbol collection is equal to the number of the code word bits to be allocated, with the following two manners being adopted: 1) excluding the worst channel according to the bit metric, and allocating bits to the rest B numbers of channels; 2) selecting B numbers of optimal channels according to the bit metric and allocating bits to them.

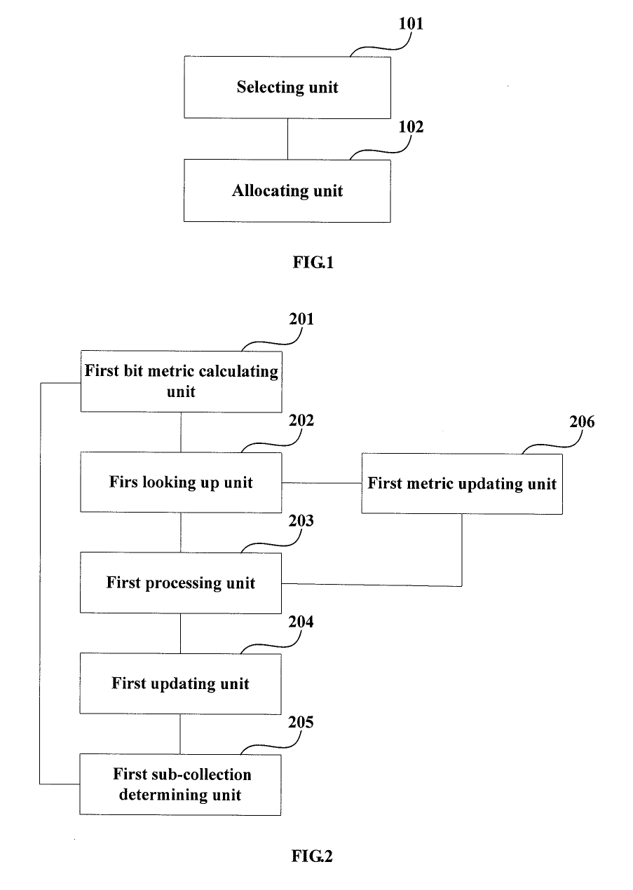

FIG. 2 is a schematic diagram showing the structure of the selecting unit of embodiment 1 of the present invention. When the first manner is adopted, the number of the modulation symbols in the initial modulation symbol collection equals to D, the initial modulation order m is the maximum modulation orders mₘₐₓ; and as shown in FIG. 2, the selecting unit 101 comprises:

a first bit metric calculating unit 201, for calculating a bit metric Λ_{d,k}, to which each bit location on each modulation symbol corresponds, according to a current modulation order m of each modulation symbol in the current collection Z of modulation symbols; wherein d represents a modulation symbol in the collection of modulation symbols, and k represents a bit location on the modulation symbol d;

a first looking-up unit 202, for looking up a modulation symbol \hat{d} having the smallest bit metric from the bit metric Λ_{d,k} calculated by the first bit metric calculating unit 201;

a first processing unit 203, for decreasing by one order the current modulation order m of the modulation symbol \hat{d} looked up by the first looking-up unit 202;

a first updating unit 204, for excluding the modulation symbol \hat{d} from the collection Z of modulation symbols when the current modulation order m of the modulation symbol \hat{d} is decreased to zero order, to update the collection Z of modulation symbols; and

a first sub-collection determining unit 205, for determining the updated collection Z of modulation symbols as the sub-collection of modulation symbols when a sum of numbers of bits on each modulation symbol in the updated collection Z of modulation symbols is equal to a number of code word bits to be allocated

$$( {\sum }_{d ∈ Z} {N}_{d} = B ) ,$$

and for taking the updated collection Z of modulation symbols as the current collection of modulation symbols when the sum of numbers of bits on each modulation symbol in the updated collection Z of modulation symbols is not equal to the number of the code word bits to be allocated, and returning to the first bit metric calculating unit 201 until the collection Z of modulation symbols is found.

As shown in FIG. 2, the selecting unit 101 further comprises a first bit metric updating unit 206, for updating a bit metric, to which each bit location on the modulation symbol \hat{d} corresponds, according to the decreased modulation order of the modulation symbol \hat{d} when the current modulation order m of the modulation symbol \hat{d} is not decreased to zero order; and

the first looking-up unit 202 looks up the modulation symbol \hat{d} having the smallest bit metric from the updated and not-updated bit metrics, and then returns to the first processing unit 203, until the collection Z modulation symbols is found, such that the number of the bits on each of the modulation symbols in the collection Z modulation symbols equals to the number of the code word bits to be allocated

$$( {\sum }_{d ∈ Z} {N}_{d} = B ) .$$

In this embodiment:

1) during initialization

the initial modulation scheme for each of the modulation symbols is set as the modulation scheme with the highest order mₘₐₓ, that is, the initial modulation scheme for each of the modulation symbols is a modulation scheme with the highest order, such as 64QAM, and 2×3=6 bits may be placed on each of the modulation symbols.

a collection Z of modulation symbols during initiation contains all the modulation symbols.

power is evenly allocated on D numbers of modulation symbols.

the first bit metric calculating unit 201 calculates the bit metric Λ_{d,k}, dεZ of each of the modulation symbols in the collection Z of modulation symbols according to the formulae (1-1), (1-2) and (1-3), or the formulae (4-1), (4-2) and (4-3).

2) if the order of the modulation symbol with the smallest bit metric in the collection Z of modulation symbols is decreased, the bit metric of the modulation symbol may be calculated according to its current modulation order by using a corresponding formula; if the modulation scheme is changed to 16QAM from 64QAM, the modulation order is decreased to 2 from 3, and 2×2=4 bits may be placed on the modulation symbol; and if the modulation scheme is changed to QPSK from 16QAM, the modulation order is decreased to 1 from 2, and 2×1=2 bits may be placed on the modulation symbol.

Following description is provided taking that the modulation scheme is 64QAM and B numbers of code word bits are mapped to D numbers of modulation symbols as an example.

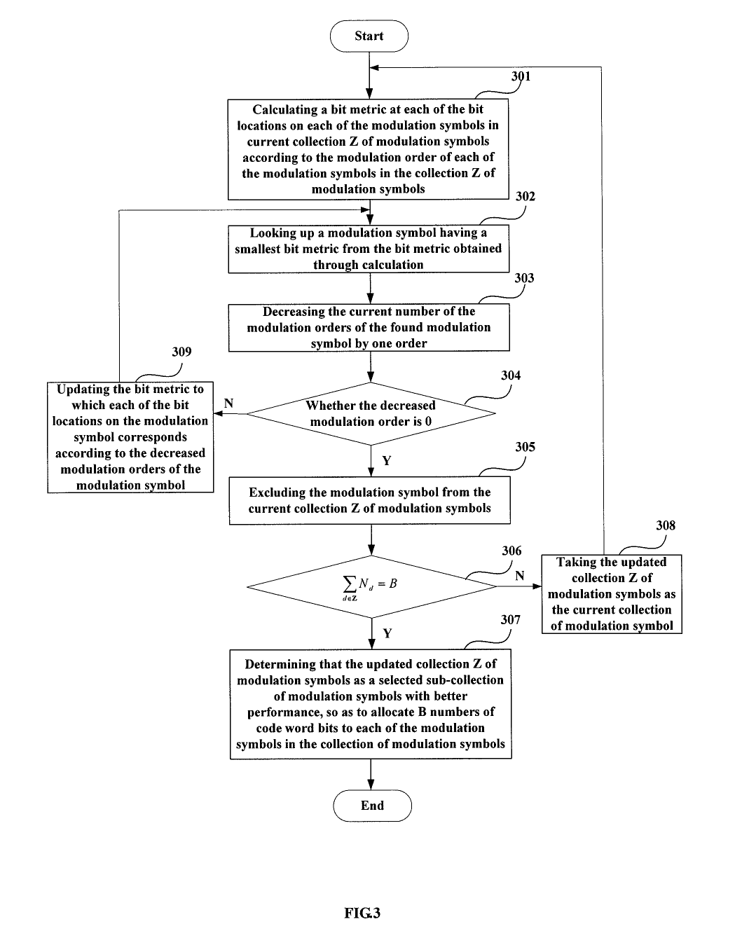

FIG. 3 is a flowchart showing the operation of the bit allocation apparatus according to Embodiment 1 of the present invention. As shown in FIG. 3, when bits are allocated using the method shown in FIG. 2, it comprises:

step 301: calculating a bit metric Λ_{d,k}, dεZ at each of the bit locations on each of the modulation symbols in a collection Z of modulation symbols according to the modulation order of each of the modulation symbols in the collection Z of modulation symbols;

where, d represents a modulation symbol in the collection of modulation symbols, and k represents the bits on the modulation symbol d;

during initiation, the number of modulation symbols contained in the current collection Z of modulation symbols is D, the modulation order is the highest, and the number of the bit locations on the modulation symbol is 2×D×mₘₐₓ (corresponding to that D numbers of modulation symbols in the collection Z of modulation symbols are made to be equivalent to 2×D×mₘₐₓ numbers of binary channels);

during initiation, the bit metric Λ_{d,k} may be calculated using formulae (1-1), (1-2) and (1-3), or the formulae (4-1), (4-2) and (4-3);

step 302: looking up a modulation symbol \hat{d} having a smallest bit metric from the bit metric Λ_{d,k} obtained through calculation (\hat{d}=argmin_{dεZ}{Λ_{d,k}});

step 303: decreasing the current modulation order m the found modulation symbol \hat{d} by one order;

wherein, if the current order is 3, then the order is decreased to 2; and if the current order is 1, then the order is decreased to 0;

step 304: judging whether the decreased modulation order is 0; executing step 305 if the judging result is 0 order; and executing step 309 if the judging result is not 0 order;

step 305: excluding the modulation symbol \hat{d} from the current collection Z of modulation symbols if the current modulation order m of the modulation symbol \hat{d} is decreased to 0 order, and updating the collection Z of modulation symbols;

step 306: judging whether the sum of the numbers of bits of each of the modulation symbols in the updated collection Z of modulation symbols is equal to the number of the code word bits to be allocated; executing step 307 if the sum is equal to the number, otherwise, executing step 308;

step 307: determining that the updated collection Z of modulation symbols is a selected collection of modulation symbols with better performance if the sum of the numbers of bits of each of the modulation symbols in the updated collection Z of modulation symbols is equal to the number of the code word bits to be allocated in step 306, i.e.

$${\sum }_{d ∈ Z} {N}_{d} = B ,$$

so as to allocate B numbers of code word bits to each of the modulation symbols in the collection of modulation symbols;

step 308: taking the updated collection Z of modulation symbols as the current collection of modulation symbols and returning to step 301 if the sum of the numbers of bits of each of the modulation symbols in the updated collection Z of modulation symbols

$$( {\sum }_{d ∈ Z} {N}_{d} )$$

is unequal to the number B of the code word bits to be allocated in step 306;

step 309: updating the bit metric to which each of the bit locations on the modulation symbol \hat{d} corresponds according to the decreased modulation orders of the modulation symbol \hat{d} if the current modulation order m of the modulation symbol \hat{d} is not decreased to 0 order; and then returning back to step 303 and looking up the modulation symbol \hat{d} having a smallest bit metric from the updated bit metric and the bit metric that is not updated, until a collection of modulation symbols is found, such that the sum of the numbers of bits of each of the modulation symbols in the collection of modulation symbols is equal to the predetermined number of the code word bits, i.e.

$${\sum }_{d ∈ Z} {N}_{d} = B .$$

In the above embodiment, step 307 maybe carried out by an allocating unit, and others may be carried out by a selecting unit.

It can be seen from what is described above that the equivalent channel quality of each of the bit locations in each of the modulation symbols may be indicated by a bit metric. Thus, when the multi-order modulating channels on each of the modulation symbols are made to be equivalent to simple and united binary channels, a sub-collection with good performance may be selected from the collection of modulation symbols according to the bit metric, so as to allocate bits to this sub-collection, thereby simplifying greatly the ABL algorithm, and the bit metric may ensure that the demodulation algorithm outputs optimal soft demodulation information.

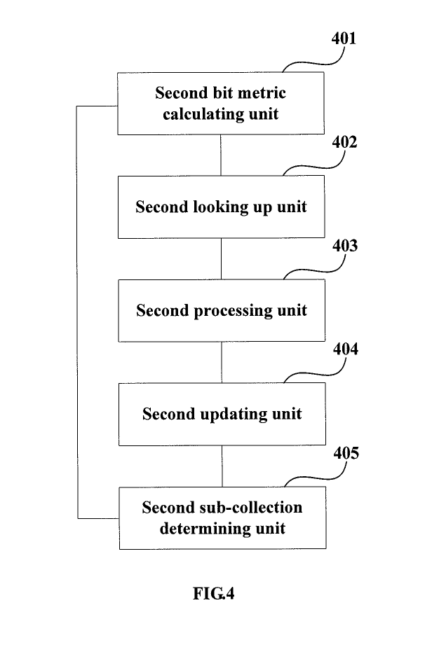

FIG. 4 is a schematic view illustrating the configuration of the selecting unit 101 of Embodiment 1 of the present invention. When the second manner is used, the number of the modulation symbols in the initial collection Z of modulation symbols is equal to 0; and the modulation order of the initial modulation symbols is 0; as shown in FIG. 4, the selecting unit 101 comprises:

a second bit metric calculating unit 401, for calculating, with respect to a modulation symbol whose current modulation order is not the highest order, a bit metric Λ_{d,k}, to which each bit location on the modulation symbol whose current modulation order is not the highest order corresponds, according to a modulation order increased by one order from the current modulation order; wherein d represents a modulation symbol in the collection Z of modulation symbols, and k represents a bit location on the modulation symbol d;

a second looking-up unit 402, for looking up a modulation symbol \hat{d} having the greatest bit metric from the bit metric Λ_{d,k} obtained by the second bit metric calculating unit 401; a second processing unit 403, for increasing by one order the current modulation order m of the modulation symbol \hat{d} looked up by the second looking-up unit 402;

a second updating unit 404, for adding the modulation symbol \hat{d} processed by the second processing unit 403 into the current collection Z of modulation symbols, to update the collection Z of modulation symbols; and

a second sub-collection determining unit 405, for determining the updated collection Z of modulation symbols as a sub-collection of modulation symbols when a sum of numbers of bits on each modulation symbol in the updated collection Z of modulation symbols is equal to a number of code word bits to be allocated

$$( {\sum }_{d ∈ Z} {N}_{d} = B ) ,$$

and for returning back to the second bit metric calculating unit 401 when the of numbers of bits on each modulation symbol in the updated collection Z of modulation symbols is not equal to the number of code word bits to be allocated, until the collection Z of modulation symbols is found, so that the of numbers of bits on each modulation symbol in the updated collection Z of modulation symbols is equal to the number of code word bits to be allocated.

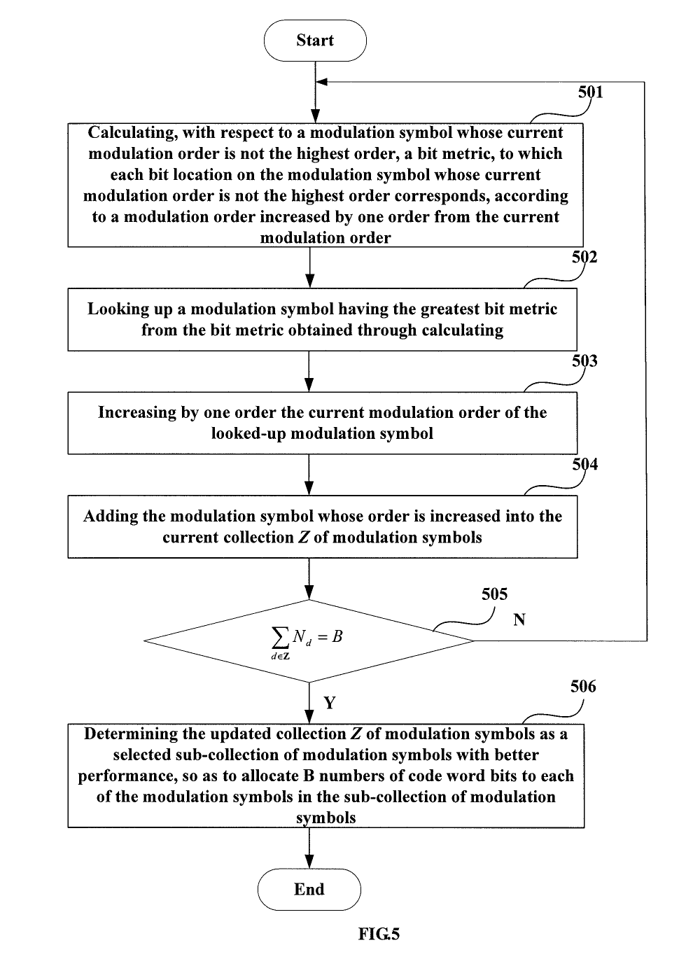

FIG. 5 is a flowchart showing the operation of the bit allocation apparatus according to Embodiment 1 of the present invention. When the manner shown in FIG. 4 is used to allocate bits, as shown in FIG. 5, it comprises:

step 501: calculating, with respect to a modulation symbol whose current modulation order is not the highest order, a bit metric Λ_{d,k} to which each bit location on the modulation symbol whose current modulation order is not the highest order corresponds, according to a modulation order increased by one order from the current modulation order;

wherein d represents a modulation symbol in the collection Z of modulation symbols, and k represents a bit location on the modulation symbol d;

during initiation, the number of modulation symbols in the collection Z of modulation symbols is equal to 0, and the modulation order of the initial modulation symbol is 0;

thus, during initiation, a bit metric Λ_{d,k}, to which each bit location on the modulation symbol whose current modulation order is not the highest order corresponds, is calculated according to a modulation order increased by one order from the current modulation order, i.e. one order; and at this time, the bit metric Λ_{d,k}, dεZ may be calculated according to formula (3-1) or formula (6-1);

step 502: looking up a modulation symbol \hat{d} having the greatest bit metric from the bit metric Λ_{d,k} obtained through calculating (\hat{d}=argmax_{dεZ}{Λ_{d,k}});

step 503: increasing by one order the current modulation order m of the looked-up modulation symbol \hat{d};

wherein, if the current number of orders is 1, the number of orders is increased to 2; and if the current number of orders is 2, the number of orders is increased to 3;

step 504: adding the modulation symbol \hat{d} whose order is increased into the current collection Z of modulation symbols, to update the collection Z of modulation symbols;

step 505: judging whether the sum of the numbers of the bits on each of the modulation symbols in the updated collection Z of modulation symbols is equal to the number of code word bits to be allocated; and executing step 506 if the sum is equal to the number, otherwise, executing step 507;

step 506: determining the updated collection Z of modulation symbols as a selected sub-collection of modulation symbols with better performance if a sum of numbers of bits on each modulation symbol in the updated collection of modulation symbols is equal to a number of code word bits to be allocated in step 505, i.e.

$${\sum }_{d ∈ Z} {N}_{d} = B ,$$

so as to allocate B numbers of code word bits to each of the modulation symbols in the sub-collection of modulation symbols; and

step 507: returning back to step 502 if the sum of numbers of bits on each modulation symbol in the updated collection Z of modulation symbols

$$( {\sum }_{d ∈ Z} {N}_{d} )$$

is not equal to the number B of code word bits to be allocated in step 505, until the collection of modulation symbols is found, such that sum of numbers of bits on each modulation symbol in the collection of modulation symbols is equal to a predetermined number of code word bits, i.e.

$${\sum }_{d ∈ Z} {N}_{d} = B .$$

In the above embodiment, step 507 maybe carried out by an allocating unit, and others may be carried out by a selecting unit.

It can be seen from what is described above that the equivalent channel quality of each of the bit locations in each of the modulation symbols may be indicated by a bit metric. Thus, when the multi-order modulating channels on each of the modulation symbols are made to be equivalent to simple and united binary channels, a sub-collection with good performance may be selected from the collection of modulation symbols according to the bit metric, so as to allocate bits to this sub-collection, thereby simplifying greatly the ABL algorithm, and the bit metric may ensure that the demodulation algorithm outputs optimal soft demodulation information.

In the above embodiment, during initiation, power is allocated evenly on D numbers of modulation symbols. If the number of the modulation symbols in the collection of modulation symbols selected by the selecting unit 101 is less than D, the power allocation coefficient of each of the modulation symbols may be calculated according to the modulation scheme of each of the modulation symbols; and the power of each of the modulation symbols in the collection of modulation symbols may be determined according to the power allocation coefficient and the total transmission power. The detailed algorithm will be described in the following embodiments, and shall not be described here any further.

In the above embodiment, in a case of multi-carriers, the modulation symbol corresponds to a subcarrier, the collection of modulation symbols corresponds to a collection of subcarriers, and the manner of allocating bits is similar to what is described above, which shall not described any further. Table 1 is an example of bit allocation in a case of multi-carriers of embodiment 2. For example, the number D of the subcarriers is 16 (D=16), the number B of pre-allocated bits is 62 (B=62), the 62 code word bits are mapped to 16 subcarriers, and [0, 2, 4, 6] bits may be placed on each of the subcarriers according to the modulation order [0, 1, 2, 3]. Wherein B<D×2×modulation orders, that is, there will be redundant subcarriers if each of the subcarriers is allocated according to the highest modulation order.

TABLE 1

| Sub- | | | | | | | | | | | | | | | | | | | |
|---|---|---|---|---|---|---|---|---|---|---|---|---|---|---|---|---|---|---|---|
| carriers | CSI | Initiation | #1 | #2 | #3 | #4 | #5 | #6 | #7 | #8 | #9 | #10 | #11 | #12 | #13 | #14 | #15 | #16 | #17 |
| 1 | 1.84 | 6 | 6 | 6 | 6 | 6 | 6 | 6 | 6 | 6 | 6 | 6 | 6 | 6 | 6 | 6 | 6 | 6 | 6 |
| 2 | 3.49 | 6 | 6 | 6 | 6 | 6 | 6 | 6 | 6 | 6 | 6 | 6 | 6 | 6 | 6 | 6 | 6 | 6 | 6 |
| 3 | 0.31 | 6 | 6 | 6 | 6 | 6 | 6 | 6 | 4 | 4 | 4 | 4 | 4 | 4 | 4 | 4 | 4 | 4 | 2 |
| 4 | 2.08 | 6 | 6 | 6 | 6 | 6 | 6 | 6 | 6 | 6 | 6 | 6 | 6 | 6 | 6 | 6 | 6 | 6 | 6 |
| 5 | 0.42 | 6 | 6 | 6 | 6 | 6 | 6 | 6 | 6 | 6 | 6 | 4 | 4 | 4 | 4 | 4 | 4 | 4 | 4 |
| 6 | 1.88 | 6 | 6 | 6 | 6 | 6 | 6 | 6 | 6 | 6 | 6 | 6 | 6 | 6 | 6 | 6 | 6 | 6 | 6 |
| 7 | 0.90 | 6 | 6 | 6 | 6 | 6 | 6 | 6 | 6 | 6 | 6 | 6 | 6 | 6 | 6 | 6 | 4 | 4 | 4 |
| 8 | 0.08 | 6 | 6 | 6 | 4 | 4 | 4 | 4 | 4 | 2 | 2 | 2 | 2 | 2 | 2 | 2 | 2 | 2 | 2 |
| 9 | 0.13 | 6 | 6 | 6 | 6 | 6 | 4 | 4 | 4 | 4 | 4 | 4 | 2 | 2 | 2 | 2 | 2 | 2 | 2 |
| 10 | 0.70 | 6 | 6 | 6 | 6 | 6 | 6 | 6 | 6 | 6 | 6 | 6 | 6 | 4 | 4 | 4 | 4 | 4 | 4 |
| 11 | 1.53 | 6 | 6 | 6 | 6 | 6 | 6 | 6 | 6 | 6 | 6 | 6 | 6 | 6 | 6 | 6 | 6 | 6 | 6 |
| 12 | 0.79 | 6 | 6 | 6 | 6 | 6 | 6 | 6 | 6 | 6 | 6 | 6 | 6 | 6 | 6 | 4 | 4 | 4 | 4 |
| 13 | 1.05 | 6 | 6 | 6 | 6 | 6 | 6 | 6 | 6 | 6 | 6 | 6 | 6 | 6 | 6 | 6 | 6 | 4 | 4 |
| 14 | 0.17 | 6 | 6 | 6 | 6 | 6 | 6 | 4 | 4 | 4 | 4 | 4 | 4 | 4 | 2 | 2 | 2 | 2 | 2 |
| 15 | 0.38 | 6 | 6 | 6 | 6 | 6 | 6 | 6 | 6 | 6 | 4 | 4 | 4 | 4 | 4 | 4 | 4 | 4 | 4 |
| 16 | 0.01 | 6 | 4 | 2 | 2 | 0 | 0 | 0 | 0 | 0 | 0 | 0 | 0 | 0 | 0 | 0 | 0 | 0 | 0 |

As shown in Table 1, if the first manner is used, i.e. the worse channel is excluded according to the bit metric, and B channels are left to be allocated bits, then all the subcarriers with indexes [1, 2, . . . 16] are included in the initial collection of subcarriers, with the initial number of orders of each of the subcarriers being 3. Thus, the all numbers of the bits placed on each of the subcarriers are 6, and at this time, the number of bits that may be placed on 16 subcarriers is 16×6=96.

In #1, bit metrics are calculated according to formulae (1-1), (1-2), (1-3), or formulae (4-1), (4-2), (4-3), and the smallest bit metric is found from the bit metrics obtained through calculating. As shown in Table 1, if the subcarrier to which the smallest bit metric corresponds is the subcarrier with index 16, the modulation order of the subcarrier with index 16 is decreased to 2 from 3, the number of bits placed on the subcarrier is 4, and the numbers of bits placed on other subcarriers remain unchanged, that are 6. At this time, the number of bits that may be placed on 16 subcarriers is 15×6+4=94.

In #2, the bit metric of the subcarrier with index 16 is calculated according to formulae (2-1), (2-2), or (5-1), (5-6), and the bit metrics of other subcarriers are still calculated according to formulae (1-1), (1-2), (1-3), or formulae (4-1), (4-2), (4-3). As shown in Table 1, if the subcarrier to which the minimum of the bit metric corresponds is still the subcarrier with index 16, then the modulation order of the subcarrier with index 16 is decreased to 1 from 2, the number of bits placed on the this subcarrier is 2, and the number of bits placed on other subcarriers remain unchanged, that are 6. At this time, the number of bits that may be placed on 16 subcarriers is 15×6+2=92.

In #3, the bit metric of the subcarrier with index 16 is calculated according to formulae (3-1) or (6-1), and the bit metrics of other subcarriers are still calculated according to formulae (1-1), (1-2), (1-3), or formulae (4-1), (4-2), (4-3). As shown in Table 1, if the subcarrier to which the minimum of the bit metric corresponds is the subcarrier with index 8, then the modulation order of the subcarrier 8 is decreased to 2 from 3, the number of bits placed on the subcarrier with index 8 is 4, and the number of bits placed on the subcarrier with index 16 is still 2, with the number of bits placed on other subcarriers being unchanged, which is still 6. At this time, the number of bits that may be placed on 16 subcarriers is 14×6+4+2=90.

Likewise, in #4, the modulation order of the subcarrier with index 16 is decreased to 0 order, the subcarrier with index 16 is excluded from the collection of subcarriers, and the updated collection of subcarriers includes subcarriers with index [1, 2, . . . 15]. At this time, the number of bits that may be placed on 15 subcarriers is 14×6+4=88.

Likewise, in #17, the collection of subcarriers includes subcarriers with index [1, 2, . . . 15], and the number of bits that may be placed on 15 subcarriers is 62.

In this way, 62 code word bits are allocated to 15 subcarriers in the above step. Thus, a sub-collection with good performance may be selected from the collection of subcarriers according to the bit metric through indicating the equivalent channel quality of each of the bit locations in each modulation symbol, so as to allocate bits to the selected sub-collection, thereby simplifying greatly the ABL algorithm, and the bit metric may ensure that the demodulation algorithm output optimal soft demodulation information.

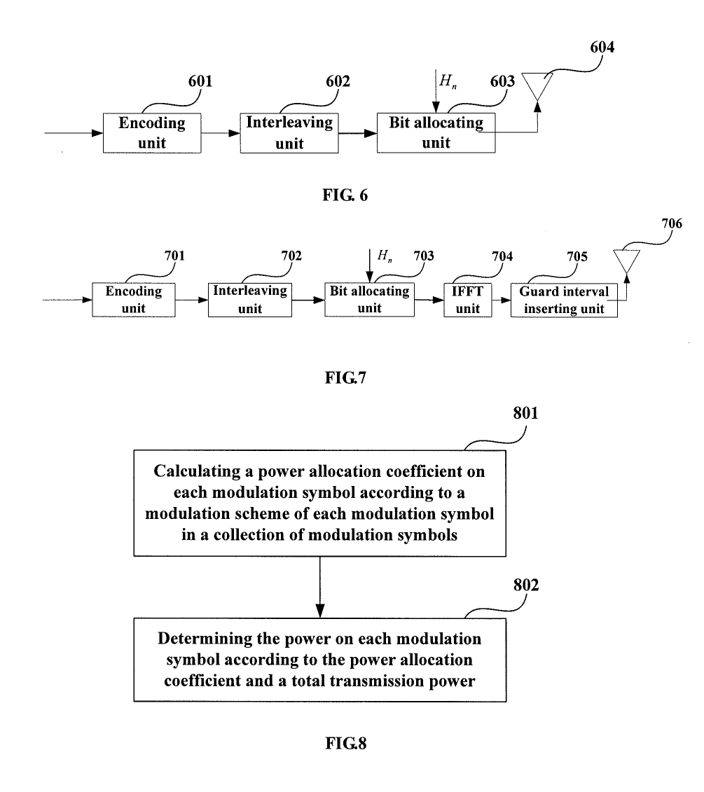

FIG. 6 is a schematic view illustrating the configuration of the transmitter according to Embodiment 3 of the present invention. As shown in FIG. 6, the transmitter comprises:

an encoding unit 601, for encoding information to be transmitted;

an interleaving unit 602, connected with the encoding unit 601, for interleaving the encoded information;

a bit allocating unit 603, connected with the interleaving unit 602, for allocating the interleaved information to a predetermined number of symbols; wherein configuration of the bit allocating unit 603 is similar to what is described in embodiment 1, which shall not be described any further; and

a transmitting unit 604, connected with the bit allocating unit 603, for transmitting the information.

FIG. 7 is a schematic view illustrating the configuration of the transmitter according to Embodiment 4 of the present invention. The transmitter is applicable to a multicarrier OFDM system.

As shown in FIG. 7, the transmitter comprises an encoding unit 701, an interleaving unit 702, a bit allocating unit 703, and a transmitting unit 706, with the functions being the same as those in embodiment 3, which shall not be described any further.

In addition, in order to realize OFDM, the transmitter further comprises an inverse fast Fourier transform (IFFT) unit 704 and a guard interval inserting unit 705; wherein the functions of the IFFT unit 704 and the guard interval inserting unit 705 are similar to those in the prior art (refer to “Adaptive Bit Loading for BICM-OFDM with Square Lattice QAM Constellations”, Communications, 2008. ICC'08. IEEE International Conference on 19-23 May 2008), which will be described here in brief. Wherein the IFFT unit 704 is used to perform an inverse Fourier transform to the code word bits allocated to the subcarriers and then transmit them to the guard interval inserting unit 705, and after the guard interval is inserted into the guard interval inserting unit 705, the carriers are sent to the transmitting unit 706 for transmission.

Furthermore, in the transmitter shown in FIGS. 6 and 7, a power allocating unit (not shown) may also be included for calculating the power allocation coefficient of each of the modulation symbols according to the modulation scheme of each of the modulation symbol in the collection of modulation symbols determined by the bit allocating units 603 and 703, and determining the power of each of the modulation symbols in the sub-collection of modulation symbols according to the power allocation coefficient and a total transmission power.

In the embodiments of the present invention, the power needed by each of the bits in a modulation symbol may be directly calculated according to the bit metrics based on the bit metrics described in the above embodiments, and furthermore, the actual power allocation of each of the m-ary modulation symbols (OFDM modulation symbols) is calculated.

Wherein three power allocation coefficients γₗ, γ̅ₗ, \hat{γ}ₗ of each of the modulation symbols may be defined according to the formulae of bit metrics in the above embodiment 1, i.e. formula (1) and formula (2), with each of the modulation schemes corresponding to three different formulae:

1) for a modulation scheme of QPSK, the power allocation coefficient is:

γₗ=|hₗ|² (7-1)

γ̅ₗ=|hₗ|² (7-2)

\hat{γ}ₗ=|hₗ|² (7-3)

2) for a modulation scheme of 16 QAM, the power allocation coefficient is:

γₗ=|hₗ|²/5 (8-1)

γ̅ₗ=(|hₗ|²/5+|hₗ|²/\sqrt{5})/2 (8-2)

\hat{γ}ₗ=|hₗ|²/\sqrt{5} (8-3)

3) for a modulation scheme of 64QAM, the power allocation coefficient is:

γₗ=|hₗ|²/21 (9-1)

γ̅ₗ=(|hₗ|²/21+\sqrt{5}|hₗ|²/21+|hₗ|²/\sqrt{21})/3 (9-2)

\hat{γ}ₗ=|hₗ|²/\sqrt{21} (9-3)

The values of power of each of the modulation symbols may be determined according the above power allocation coefficients by using the formula as follows:

$${P}_{l}^{′} = \frac{{P}_{T}}{{γ}_{l}^{*} \cdot {\sum }_{l ∈ L} \frac{1}{{γ}_{l}^{*}}} \qquad ( 10 )$$

where, any one of γ, γ̅, \hat{γ} may be taken as γ*, and P_{T} is the limit of the total transmission power.

FIG. 8 is a flowchart showing the power allocation method according to Embodiment 5 of the present invention. As shown in FIG. 8, the method comprises:

step 801: calculating a power allocation coefficient on each modulation symbol according to a modulation scheme of each modulation symbol in a collection of modulation symbols; the power allocation coefficient being obtained according to a signal-to-noise ratio or a channel gain of each of the modulation symbols, and according to a modulation order and a location of each bit at the modulation symbols;

wherein the above formula may be used in calculation, which shall not be described any further.

step 802: determining the power on each modulation symbol according to the power allocation coefficient and a total transmission power;

wherein the power of each modulation symbol may be calculated using the following formula:

$${P}_{l}^{′} = \frac{{P}_{T}}{{γ}_{l}^{*} \cdot {\sum }_{l ∈ L} \frac{1}{{γ}_{l}^{*}}}$$

where, Pₗ′ is the power needed by each modulation symbol; P_{T} is the total transmission power; and γₗ* is the power allocation coefficient.

Wherein, different power allocation coefficients may be adopted in different cases.

For example, for leveling the worse binary channel power to which each of the M-ary channels corresponds:

the power allocation coefficient of each of the modulation symbols is γₗ, and for different modulation schemes, the coefficient may be calculated using formulae (7-1), (8-1), (9-1);

the power value Pₗ′ needed by each of the modulation symbols may be determined according to the following formula:

$${P}_{l}^{′} = \frac{{P}_{T}}{{γ}_{l} \cdot {\sum }_{l ∈ L} \frac{1}{{γ}_{l} }}$$

where, P_{T} is the limit of the total transmission power.

For example, for leveling the average binary channel power to which each of the M-ary channels corresponds:

the power allocation coefficient of each of the modulation symbols is γ̅ₗ, and for different modulation schemes, the coefficient may be calculated using formulae (7-2), (8-2), (9-2);

the power value Pₗ′ needed by each of the modulation symbols may be determined according to the following formula:

$${P}_{l}^{′} = \frac{{P}_{T}}{{\overline{γ}}_{l} \cdot {\sum }_{l ∈ L} \frac{1}{{\overline{γ}}_{l}}}$$

where, P_{T} is the limit of the total transmission power.

For example, for leveling the best binary channel power to which each of the M-ary channels corresponds:

the power allocation coefficient of each of the modulation symbols is \hat{γ}ₗ, and for different modulation schemes, the coefficient may be calculated using formulae (7-3), (8-3), (9-3);

the power value Pₗ′ needed by each of the modulation symbols may be determined according to the following formula:

$${P}_{l}^{′} = \frac{{P}_{T}}{{\hat{γ}}_{l} \cdot {\sum }_{l ∈ L} \frac{1}{{\hat{γ}}_{l}}}$$

where, P_{T} is the limit of the total transmission power.

In the above embodiment, the modulation symbol corresponds to a subcarrier in case of multicarriers.

It can be seen from the above embodiment that a sub-collection with good performance may be selected from the collection of subcarriers according to the bit metric indicative of the equivalent channel quality of each of the bit locations in each modulation symbol, so as to allocate the bits to the selected sub-selection, thereby simplifying greatly the ABL algorithm, and the bit metric may ensure that the demodulation algorithm outputs optimal soft demodulation information; furthermore, the power needed by each of the modulation symbols or subcarriers may be calculated in a simple manner.

The above devices and methods of the present invention may be implemented by hardware, and may also be implemented by hardware in combination with software.

The present invention relates to such a computer-readable program that when the program is executed by a logic part, it enables the logic part to realize the above-described devices or components, or enables the logic part to realize all the methods and steps as described above. The present invention relates also to a storage medium storing the above program, such as a hard disc, a floppy disc, a compacted disc, a DVD, and a flash memory, etc.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

The present invention is described above with reference to particular embodiments. However, it should be understood by those skilled in the art that such descriptions are exemplary only, and are intended to limit the protection scope of the present invention. Various variants and modifications may be made by those skilled in the art according to the spirits and principle of the present invention, and such variants and modifications also fall within the scope of the present invention.

The modes for carrying out the present invention including the above embodiments further disclose the following supplements.

(Supplement 1). A bit allocation apparatus, comprising:

a selecting unit, for selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and

an allocating unit, for allocating code word bits to be allocated to modulation symbols in the collection of modulation symbols selected by the selecting unit.

(Supplement 2). The apparatus according to supplement 1, wherein the bit metric is associated with a signal-to-noise ratio or a channel gain on the plurality of modulation symbols, and with a bit location of the code word bits at the modulation symbols and a modulation order.

(Supplement 3). The apparatus according to supplement 1, wherein the number of the plurality of modulation symbols is D, the number of the code word bits to be allocated is B, the number of modulation symbols in the initial collection Z of modulation symbols is equal to D, and the initial modulation order of each modulation symbol is the highest modulation order;

the selecting unit comprising:

a first bit metric calculating unit, for calculating a bit metric Λ_{d,k}, to which each bit location on each modulation symbol corresponds, according to a current modulation order m of each modulation symbol in the current collection Z of modulation symbols; wherein d represents a modulation symbol in the collection of modulation symbols, and k represents a bit location on the modulation symbol d;

a first looking-up unit, for looking up a modulation symbol d having the smallest bit metric from the bit metric Λ_{d,k} calculated by the first bit metric calculating unit;

a first processing unit, for decreasing by one order the current modulation order m of the modulation symbol \hat{d} looked up by the first looking-up unit;

a first updating unit, for excluding the modulation symbol \hat{d} looked up by the first looking-up unit from the current collection Z of modulation symbols when the current modulation order m of the modulation symbol \hat{d} looked up by the first looking-up unit is decreased to zero order, to update the collection Z of modulation symbols; and

a first sub-collection determining unit, for determining the updated collection Z of modulation symbols as the selected collection of modulation symbols when a sum of numbers of bits on each modulation symbol in the updated collection Z of modulation symbols is equal to a number

$${\sum }_{d ∈ Z} {N}_{d} = B$$

of code word bits to be allocated, and for taking the updated collection Z of modulation symbols as the current collection of modulation symbols when the sum of numbers of bits on each modulation symbol in the updated collection Z of modulation symbols is not equal to the number of code word bits to be allocated, and returning to the first bit metric calculating unit until the collection Z of modulation symbols is found.

(Supplement 4). The apparatus according to supplement 3, wherein the selecting unit further comprises:

a first bit metric updating unit, for updating a bit metric, to which each bit location on the modulation symbol \hat{d} corresponds, according to the decreased modulation order of the modulation symbol \hat{d} when the current modulation order m of the modulation symbol \hat{d} looked up by the first looking-up unit is not decreased to zero order; and

the first looking-up unit looks up the modulation symbol \hat{d} having the smallest bit metric from the updated and not-updated bit metrics.

(Supplement 5). The apparatus according to supplement 1, wherein the number of the plurality of modulation symbols is D, the number of the code word bits to be allocated is B, the number of modulation symbols in the initial collection Z of modulation symbols is equal to D, and the initial modulation order of the modulation symbol is 0;

the selecting unit comprising:

a second bit metric calculating unit, for calculating, with respect to a modulation symbol whose current modulation order is not the highest order, a bit metric Λ_{d,k}, to which each bit location on the modulation symbol whose current modulation order is not the highest order corresponds, according to a modulation order increased by one order from the current modulation order; wherein d represents a modulation symbol in the collection of modulation symbols, and k represents a bit location on the modulation symbol d; a second looking-up unit, for looking up a modulation symbol \hat{d} having the greatest bit metric from the bit metric Λ_{d,k} obtained by the second bit metric calculating unit;

a second processing unit, for increasing by one order the current modulation order m of the modulation symbol \hat{d} looked up by the second looking-up unit;

a second updating unit, for adding the modulation symbol \hat{d} processed by the second processing unit to the current collection Z of modulation symbols, to update the collection Z of modulation symbols; and

a second sub-collection determining unit, for determining the updated collection Z of modulation symbols as a sub-collection of modulation symbols when a sum of numbers of bits on each modulation symbol in the updated collection Z of modulation symbols is equal to a number

$${\sum }_{d ∈ Z} {N}_{d} = B$$

of code word bits to be allocated, and for returning to the second bit metric calculating unit when the sum of numbers of bits on each modulation symbol in the updated collection Z of modulation symbols is not equal to the number of code word bits to be allocated, until the collection Z of modulation symbols is found.

(Supplement 6). The apparatus according to supplement 1, wherein, in the case of multi-carriers, the modulation symbol is a subcarrier, and the collection of modulation symbols is a collection of subcarriers.

(Supplement 7). A transmitter, comprising:

an encoding unit, for encoding information to be transmitted;

an interleaving unit, connected with the encoding unit, for interleaving the encoded information;

a bit allocating unit, connected with the interleaving unit, for allocating the interleaved information to a predetermined number of symbols; wherein the allocating unit comprises the bit allocation apparatus according to any one of claims 1 to 6; and

a transmitting unit, connected with the bit allocating unit, for transmitting the information.

(Supplement 8) A transmitter according to supplement 7, wherein the transmitter further comprises:

a power allocating unit, for calculating the power allocation coefficient of each of the modulation symbols according to the modulation scheme of each of the modulation symbol in the collection of modulation symbols determined by the bit allocating unit, and determining the power of each of the modulation symbols in the collection of modulation symbols according to the power allocation coefficient and a total transmission power.

(Supplement 9) A transmitter according to supplement 8, wherein in case of multicarriers, the modulation symbols are subcarriers, and the collection of modulation symbols is a collection of subcarriers.

(Supplement 10). A power allocation method, comprising:

calculating a power allocation coefficient on each modulation symbol according to a modulation scheme of each modulation symbol in a collection of modulation symbols; the power allocation coefficient being obtained according to a signal-to-noise ratio or a channel gain on each of the modulation symbols, and according to a location of each bit at the modulation symbols and a modulation order; and

determining a power on each modulation symbol according to the power allocation coefficient and a total transmission power.

(Supplement 11). The method according to supplement 10, wherein the power on each modulation symbol is expressed as

$${P}_{l}^{′} = \frac{{P}_{T}}{{γ}_{l}^{*} \cdot {\sum }_{l ∈ L} \frac{1}{{γ}_{l}^{*}}} ,$$

wherein Pₗ′ is the power needed by each modulation symbol, P_{T} is the total transmission power, and γₗ* is the power allocation coefficient.

(Supplement 12). The method according to supplement 10 or 11, wherein in case of multicarriers, the modulation symbols are subcarriers, and the collection of modulation symbols is a collection of subcarriers.

(Supplement 13). A bit allocation method, comprising:

selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and

allocating code word bits to be allocated to modulation symbols in the selected collection of modulation symbols.

(Supplement 14). The method according to supplement 13, wherein the bit metric is related to a signal-to-noise ratio or a channel gain on the modulation symbols, and to a bit location of the code word bit at the modulation symbols and a modulation order.

(Supplement 15). The method according to supplement 13, wherein the number of the plurality of modulation symbols is D, the number of the code word bits to be allocated is B, the number of modulation symbols in the initial collection Z of modulation symbols is equal to D, and the initial modulation order of each modulation symbol is the highest modulation order; and

the selecting a collection of modulation symbols from a predetermined number of modulation symbols according to a bit metric indicative of channel quality of each bit location in each modulation symbol comprises:

a first bit metric calculating step: calculating a bit metric Λ_{d,k}, to which each bit location on each modulation symbol corresponds, according to a current modulation order m of each modulation symbol in the current collection Z of modulation symbols; wherein d represents a modulation symbol in the collection of modulation symbols, and k represents a bit location on the modulation symbol d;

a first looking-up step: looking up a modulation symbol \hat{d} having the smallest bit metric from the calculated bit metric Λ_{d,k};

a first processing step: decreasing by one order the current modulation order m of the looked-up modulation symbol \hat{d};

a first updating step: excluding the looked-up modulation symbol \hat{d} from the current collection Z of modulation symbols when the current modulation order m of the looked-up modulation symbol \hat{d} is decreased to zero order, to update the collection Z of modulation symbols; and

a first sub-collection determining step: determining the updated collection Z of modulation symbols as the selected collection of modulation symbols when a sum of numbers of bits on each modulation symbol in the updated collection Z of modulation symbols is equal to a number

$${\sum }_{d ∈ Z} {N}_{d} = B$$

of pre-allocated code word bits, or taking the updated collection Z of modulation symbols as the current collection of modulation symbols when the sum of numbers of bits on each modulation symbol in the updated collection Z of modulation symbols is not equal to the number of the pre-allocated code word bits, and returning to the first bit metric calculating step until the collection Z of modulation symbols is found.

(Supplement 16). The method according to supplement 15, wherein the method further comprises:

a first bit metric updating step: updating a bit metric, to which each bit location on the modulation symbol \hat{d} corresponds, according to the decreased modulation order of the modulation symbol \hat{d} when the looked-up current modulation order m of the modulation symbol \hat{d} is not decreased to zero order, and returning to the first looking up step until the collection of modulation symbols is found.

(Supplement 17). The method according to supplement 13, wherein the number of the plurality of modulation symbols is D, the number of the code word bits to be allocated is B, the number of modulation symbols in the initial collection Z of modulation symbols is equal to 0, and the initial modulation order of the modulation symbol is 0; and

the selecting a collection of modulation symbols from a predetermined number of modulation symbols according to a bit metric indicative of channel quality of each bit location in each modulation symbol comprises:

a second bit metric calculating step: calculating, with respect to a modulation symbol whose current modulation order is not the highest order, a bit metric Λ_{d,k}, to which each bit location on the modulation symbol whose current modulation order is not the highest order corresponds, according to a modulation order increased by one order from the current modulation order; wherein d represents a modulation symbol in the collection of modulation symbols, and k represents a bit location on the modulation symbol d;

a second looking-up step: looking up a modulation symbol d having the greatest bit metric from the bit metric Λ_{d,k} obtained in the second bit metric calculating step;

a second processing step: increasing by one order the current modulation order m of the modulation symbol \hat{d} looked up in the second looking-up step;

a second updating step, adding the modulation symbol \hat{d} processed by the second processing unit into the current collection Z of modulation symbols, to update the collection Z of modulation symbols; and

a second sub-collection determining step, determining the updated collection Z of modulation symbols as a sub-collection of modulation symbols when a sum of numbers of bits on each modulation symbol in the updated collection Z of modulation symbols is equal to a number

$${\sum }_{d ∈ Z} {N}_{d} = B$$

of code word bits to be allocated, and returning to the second bit metric calculating step when the sum of numbers of bits on each modulation symbol in the updated collection Z of modulation symbols is not equal to the number of code word bits to be allocated, until the collection Z of modulation symbols is found.

(Supplement 18). The method according to supplement 13, wherein in case of multicarriers, the modulation symbols are subcarriers, and the collection of modulation symbols is a collection of subcarriers.

1. A bit allocation apparatus, comprising:
a selecting unit, for selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and
an allocating unit, for allocating code word bits to be allocated to modulation symbols in the collection of modulation symbols selected by the selecting unit.

2. The apparatus according to claim 1, wherein the bit metric is associated with a signal-to-noise ratio or a channel gain on the plurality of modulation symbols, and with a bit location of the code word bits at the modulation symbols and a modulation order.

3. The apparatus according to claim 1, wherein the number of the plurality of modulation symbols is D, the number of the code word bits to be allocated is B, the number of modulation symbols in the initial collection Z of modulation symbols is equal to D, and the initial modulation order of each modulation symbol is the highest modulation order;
the selecting unit comprising:
a first bit metric calculating unit, for calculating a bit metric Λ_{d,k}, to which each bit location on each modulation symbol corresponds, according to a current modulation order m of each modulation symbol in the current collection Z of modulation symbols; wherein d represents a modulation symbol in the collection of modulation symbols, and k represents a bit location on the modulation symbol d;
a first looking-up unit, for looking up a modulation symbol \hat{d} having the smallest bit metric from the bit metric Λ_{d,k} calculated by the first bit metric calculating unit;
a first processing unit, for decreasing by one order the current modulation order m of the modulation symbol \hat{d} looked up by the first looking-up unit;
a first updating unit, for excluding the modulation symbol \hat{d} looked up by the first looking-up unit from the current collection Z of modulation symbols when the current modulation order m of the modulation symbol \hat{d} looked up by the first looking-up unit is decreased to zero order, to update the collection Z of modulation symbols; and
a first sub-collection determining unit, for determining the updated collection Z of modulation symbols as the selected collection of modulation symbols when a sum of numbers of bits on each modulation symbol in the updated collection Z of modulation symbols is equal to a number
$${\sum }_{d ∈ Z} {N}_{d} = B$$
of code word bits to be allocated, and for taking the updated collection Z of modulation symbols as the current collection of modulation symbols when the sum of numbers of bits on each modulation symbol in the updated collection Z of modulation symbols is not equal to the number of code word bits to be allocated, and returning to the first bit metric calculating unit until the collection Z of modulation symbols is found.

4. The apparatus according to claim 3, wherein the selecting unit further comprises:
a first bit metric updating unit, for updating a bit metric, to which each bit location on the modulation symbol \hat{d} corresponds, according to the decreased modulation order of the modulation symbol \hat{d} when the current modulation order m of the modulation symbol \hat{d} looked up by the first looking-up unit is not decreased to zero order; and
the first looking-up unit looks up the modulation symbol \hat{d} having the smallest bit metric from the updated and not-updated bit metrics.

5. The apparatus according to claim 1, wherein the number of the plurality of modulation symbols is D, the number of the code word bits to be allocated is B, the number of modulation symbols in the initial collection Z of modulation symbols is equal to D, and the initial modulation order of the modulation symbol is 0;
the selecting unit comprising:
a second bit metric calculating unit, for calculating, with respect to a modulation symbol whose current modulation order is not the highest order, a bit metric Λ_{d,k}, to which each bit location on the modulation symbol whose current modulation order is not the highest order corresponds, according to a modulation order increased by one order from the current modulation order; wherein d represents a modulation symbol in the collection of modulation symbols, and k represents a bit location on the modulation symbol d;
a second looking-up unit, for looking up a modulation symbol \hat{d} having the greatest bit metric from the bit metric Λ_{d,k} obtained by the second bit metric calculating unit;
a second processing unit, for increasing by one order the current modulation order m of the modulation symbol \hat{d} looked up by the second looking-up unit;
a second updating unit, for adding the modulation symbol \hat{d} processed by the second processing unit to the current collection Z of modulation symbols, to update the collection Z of modulation symbols; and
a second sub-collection determining unit, for determining the updated collection Z of modulation symbols as a sub-collection of modulation symbols when a sum of numbers of bits on each modulation symbol in the updated collection Z of modulation symbols is equal to a number
$${\sum }_{d ∈ Z} {N}_{d} = B$$
of code word bits to be allocated, and for returning to the second bit metric calculating unit when the sum of numbers of bits on each modulation symbol in the updated collection Z of modulation symbols is not equal to the number of code word bits to be allocated, until the collection Z of modulation symbols is found.

6. The apparatus according to claim 1, wherein, in the case of multi-carriers, the modulation symbol is a subcarrier, and the collection of modulation symbols is a collection of subcarriers.

7. A transmitter, comprising:
an encoding unit, for encoding information to be transmitted;
an interleaving unit, connected with the encoding unit, for interleaving the encoded information;
a bit allocating unit, connected with the interleaving unit, for allocating the interleaved information to a predetermined number of symbols; wherein the allocating unit comprises the bit allocation apparatus according to claim 1; and
a transmitting unit, connected with the bit allocating unit, for transmitting the information.

8. A bit allocation method, comprising:
selecting a collection of modulation symbols from a predetermined number of modulation symbols according to a bit metric indicative of channel quality of each bit location in each modulation symbol, thus that a sum of numbers of bits on the modulation symbols included in the collection of modulation symbols is equal to a number of code word bits to be allocated; and
allocating code word bits to be allocated to modulation symbols in the selected collection of modulation symbols.

9. A power allocation method, comprising:
calculating a power allocation coefficient on each modulation symbol according to a modulation scheme of each modulation symbol in a collection of modulation symbols; the power allocation coefficient being obtained according to a signal-to-noise ratio or a channel gain on each of the modulation symbols, and according to a location of each bit at the modulation symbols and a modulation order; and
determining a power on each modulation symbol according to the power allocation coefficient and a total transmission power.

10. The method according to claim 9, wherein the power on each modulation symbol is expressed as
$${P}_{l}^{′} = \frac{{P}_{T}}{{γ}_{l}^{*} \cdot {\sum }_{l ∈ L} \frac{1}{{γ}_{l}^{*}}} ,$$
wherein Pₗ′ is the power needed by each modulation symbol, P_{T} is the total transmission power, and yₗ* is the power allocation coefficient.
